(19) United States
(12) Patent Application Publication
(10) Pub. No.: US 2018/0366840 A1
(43) Pub. Date: Dec. 20, 2018

(54) INSULATION-DISPLACEMENT CONNECTION TOOL AND INSULATION-DISPLACEMENT TERMINAL

(71) Applicant: Phoenix Contact GmbH & Co. KG, Blomberg (DE)

(72) Inventors: Andreas Wendt, Berlin (DE); Ralf Beckmann, Detmold (DE)

(21) Appl. No.: 16/061,368

(22) PCT Filed: Dec. 14, 2016
(86) PCT No.: PCT/EP2016/080865

§ 371 Date: Jun. 12, 2018

(30) Foreign Application Priority Data
Dec. 14, 2015 (DE) 10 2015 121 743.0

(51) Int. Cl. H01R 4/2454; H01R 43/01

(52) U.S. Cl. CPC H01R 4/2454; H01R 43/015

(57) ABSTRACT

A tool for connecting an insulation-coated electrical conductor to an insulation-displacement terminal, the insulation-displacement terminal including at least two contact elements that jointly form a conductor clamping slot and are configured for clamp-contacting the electrical conductor, includes: a housing element to be placed onto the contact elements, the housing element including a first recess for receiving a stamping element that is mounted so as to be movable in a conductor insertion direction, and a second recess for receiving the electrical conductor transversely to the conductor insertion direction. Cutting means that form a cutting region are arranged in the housing element in such a way that, when the stamping element is moved from a placed position into a clamped position in order to insert the electrical conductor into the conductor clamping slot, the insulation initially comes into engagement with the cutting means and is severed in the process, at least partially.

### CROSS-REFERENCE TO PRIOR APPLICATIONS

This application is a U.S. National Phase application under 35 U.S.C. § 371 of International Application No. PCT/EP2016/080865, filed on Dec. 14, 2016, and claims benefit to German Patent Application No. DE 10 2015 121 743.0, filed on Dec. 14, 2015. The International Application was published in German on Jun. 22, 2017 as WO 2017/102770 under PCT Article 21(2).

### FIELD

The present invention relates to a tool for connecting an insulation-coated electrical conductor to an insulation-displacement terminal. The invention further relates to an insulation-displacement terminal that is adapted and designed for clamp-contacting an insulation-coated electrical conductor.

### BACKGROUND

Insulation-displacement terminals of the type mentioned at the outset are used as conductor connection terminals, in particular as circuit board terminals. In insulation-displacement connection technology, also known as IDC technology, the insulation-coated electrical conductor to be connected is inserted into the insulation-displacement terminal without prior stripping, and is contacted by means of placement.

An insulation-displacement terminal of this type is disclosed for example by DE 88 13 518, in which the insulation of the conductor is pre-cut by means of upstream spring arms that each comprise cutters, before said insulation enters the conductor clamping slot that forms the clamping point.

It is disadvantageous that, when the conductor is inserted into the known insulation-displacement terminal in order to cut into the insulation that surrounds the electrical conductor, the force that has to be exerted for placement of the conductor acts, via the insulation-displacement terminal, on the support material, that is to say, for example, on the circuit board or the additional components connected to the insulation-displacement terminal. The known insulation-displacement solutions are therefore generally suitable only for small conductor cross sections, typically up to a maximum of 6 mm², since, when conductors that have a larger cross section are inserted, the forces acting to cut into the insulation result in damage to the circuit board or to the additional components.

### SUMMARY

In an embodiment, the present invention comprises a tool for connecting an insulation-coated electrical conductor to an insulation-displacement terminal, the insulation-displacement terminal including at least two contact elements that jointly form a conductor clamping slot and are configured for clamp-contacting the electrical conductor, the tool comprising: a housing element configured to be placed onto the contact elements, the housing element comprising a first recess configured to receive a stamping element that is mounted so as to be movable in a conductor insertion direction, and a second recess configured to receive the electrical conductor transversely to the conductor insertion direction, wherein a cutter that forms a cutting region is arranged in the housing element in such a way that, when the stamping element is moved from a placed position into a clamped position in order to insert the electrical conductor into the conductor clamping slot, the insulation initially comes into engagement with the cutter and is severed in the process, at least in part.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 schematically shows the tool according to the invention and the contact element of the insulation-displacement terminal in an exploded view.

FIG. 2 is a side view of the tool, facing the conductor end,

FIG. 3 is a side view of the tool, facing the longitudinal side of the conductor,

FIG. 4 is a plan view of the tool in the placed position,

FIG. 5 is a sectional view of the tool shown in FIG. 4 according to sectional line A-A,

FIG. 6 is a sectional view of the tool shown in FIG. 4 according to sectional line B-B,

FIG. 7 is a plan view of the tool in the clamped position,

FIG. 8 is a sectional view of the tool shown in FIG. 7 according to sectional line C-C,

FIG. 9 is a sectional view of the tool shown in FIG. 7 according to sectional line D-D,

FIG. 10 is a detailed view of the detail 1 shown in FIG. 8

FIG. 11 is a detailed view of the detail 2 shown in FIG. 9.

### DETAILED DESCRIPTION

In an embodiment the present invention provides a tool mentioned at the outset, wherein the insulation-displacement terminal comprises at least two contact elements that jointly form a conductor clamping slot and are designed for clamp-contacting the conductor, wherein the tool includes a housing element that is designed to be placed onto the contact elements, and wherein the housing element comprises a first recess for receiving a stamping element that is mounted so as to be movable in a conductor insertion direction, and a second recess that is designed to receive the conductor transversely to the conductor insertion direction, and wherein cutting means that form a cutting region are arranged in the housing element in such a way that, when the stamping element is moved from a placed position into a clamped position in order to insert the conductor into the conductor clamping slot, the insulation initially comes into engagement with the cutting means and is severed in the process, at least in part. This is advantageous in that the force required to push the electrical conductor into the conductor clamping slot is reduced since the insulation is already severed at defined points by the cutting means and put aside before it enters the conductor clamping slot. This makes it possible to also connect conductors that have a large cross section, in particular conductors that have cross sections of up to 35 mm².

An additional advantage is that the cutting means each include a double blade forming a tapered cutting gap. The insulation is thus continuously cut into more deeply in the conductor insertion direction as the electrical conductor is inserted further by the stamping element.

An expedient embodiment of the invention is characterized in that the cutting means is arranged in the housing element such that one of the cutting means is associated with each of the contact elements, with the cutting gap of the cutting means transitioning into the relevant conductor clamping slot. This ensures that the electrical conductor is inserted into the conductor clamping slot together with the regions that have previously been freed of at least some of the insulation by the cutting means. The force to be applied in order to insert the electrical conductor into the conductor clamping slot is thus considerably reduced, since the contact elements only clamps the electrical conductor; however, no insulation or insulation components have to be cut or forced out by said elements.

One preferred development of the invention is characterized in that the cutting means are wedge-shaped so as to widen in the conductor insertion direction. The wedge shape of the cutting means supports the forcing out of the insulation during the cutting-in process such that said means are free from insulation at the region of the electrical conductor provided for the entry into the conductor clamping slot and at the conductor regions that are essential for the clamp contacting.

According to a further preferred embodiment of the invention, the housing element includes holding means that are formed and designed so as to come into holding engagement with the insulation-displacement terminal in the placed position. This is advantageous in that the forces being exerted on the support material via the insulation-displacement terminal during the placement are reduced to a minimum, since the exerted forces are supported by the connection, created by the holding means, between the insulation-displacement terminal and the tool according to the invention. The entire placement and connection process of the electrical conductor on/to the insulation-displacement terminal is therefore as free as possible from forces towards the outside, with the result that no destructive forces act on the support material in the process.

An additional expedient embodiment of the invention is characterized in that the holding means are arranged and designed so as to be pivotable on the housing element in order to engage at least in part behind at least one of the contact elements in the placed position. As a result, upon placement of the tool according to the invention, a resilient connection is created between the housing element and the holding means, which achieves the above-mentioned supporting effect. An additional advantage is that the tool according to the invention is formed and designed so as to be self-locking, meaning that it locks automatically to the contact elements of the insulation-displacement terminal. This makes one-handed operation of the tool easier in particular.

According to an additional preferred embodiment, in order to detach the tool from the insulation-displacement terminal, the holding means are arranged in the clamped position in such a way that they are each designed to be outwardly pivotable by means of the stamping element. In other words, the holding means are formed and designed so as to automatically detach the connection between the tool and the insulation-displacement terminal. In this manner, it is advantageous for the connection between the tool and the insulation-displacement terminal to be automatically detached when the intended clamped position has been reached. Thus, when placing or connecting the electrical conductor on/to the insulation-displacement terminal by means of the tool according to the invention, the correct penetration depth of the electrical conductor in the conductor clamping slot can always be ensured. Moreover, the automatic detachment of the tool upon reaching the clamped position gives the user feedback regarding the correct contacting of the electrical conductor to the contact elements of the insulation-displacement terminal.

An additional expedient embodiment of the invention is characterized in that, in order to detach the tool from the insulation-displacement terminal in the clamped position, the holding means are arranged in such a way that they are each designed to be outwardly pivotable by means of the stamping element. As a result, the automatic detachment of the connection between the tool and the insulation-displacement terminal is achieved in a particularly simple constructive manner when the clamped position is reached. The stamping element is therefore formed and designed as a guide element for moving the electrical conductor out of the placed position and into the clamped position. The stamping element is also designed as a control device that interacts with the holding means in order to outwardly pivot the holding means in the clamped position.

In an embodiment, the present invention provides the insulation-displacement terminal mentioned at the outset by applying a tool having the features mentioned at the outset, the insulation-displacement terminal including contact elements that jointly form a conductor clamping slot, characterized in that the contact elements each comprise an undercut that is designed and formed so to come into holding engagement with holding means of the tool in the placed position. By means of the undercut, the tool can be reliably connected to the insulation-displacement terminal via the holding means. On account of said connection, actuation forces required to produce the clamped connection act substantially exclusively between the actuation tool according to the invention and the insulation-displacement terminal according to the invention, such that no forces—or at most, extremely low forces—act on the support material during the connection process.

According to an additional preferred embodiment, the contact elements having the undercut are trapezoidal. The trapezoidal shape of the contact elements supports the automatic locking of the holding means of the tool according to the invention to the contact elements. During the process of placing the tool onto the insulation-displacement terminal, the holding means are pushed outwards by means of the contact elements which are trapezoidal and therefore widen in the conductor insertion direction, until said means reach the undercut. After reaching the undercut and by engaging therebehind, the holding means automatically lock the tool to the insulation-displacement terminal in the placed position. In order to detach the connection between the tool and the insulation-displacement terminal, the holding means come free from the undercut—as described previously—only upon reaching the clamped position.

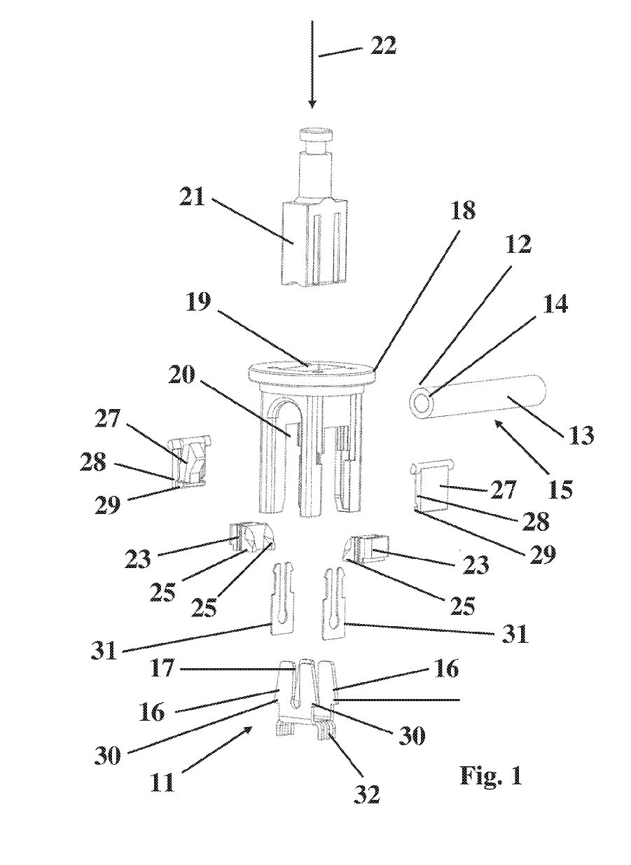

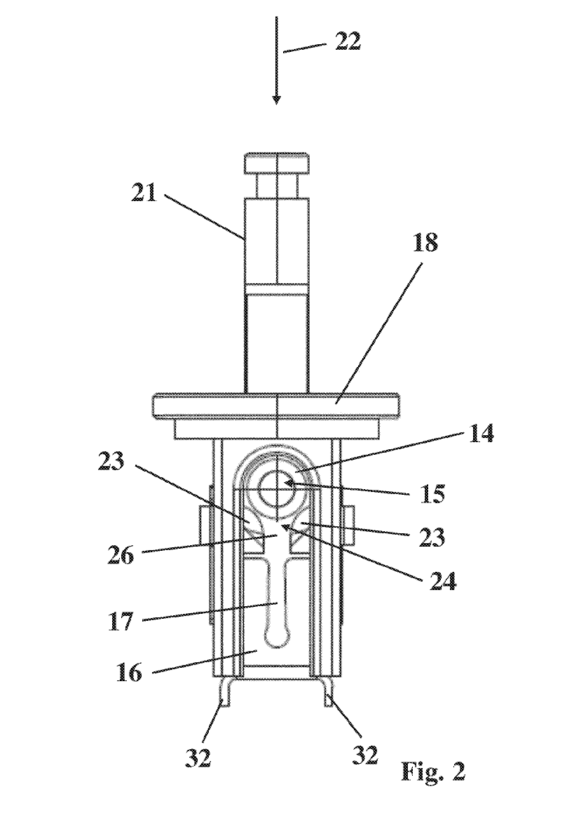

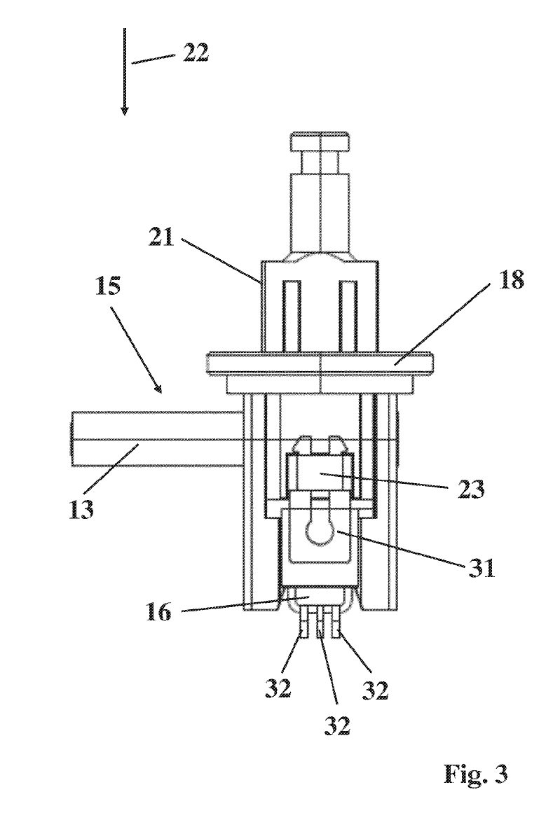

The present invention is explained in detail in the following on the basis of the above-mentioned figures. FIG. 1 schematically shows the tool according to the invention and the insulation-displacement terminal 11 in an exploded view. FIGS. 2 and 3 each show a side view of the tool, facing the conductor end 12 and facing the longitudinal side of the conductor 13, respectively.

The tool according to the invention is designed and formed so as to connect an insulation-coated 14 electrical conductor 15 to the insulation-displacement terminal 11. The insulation-displacement terminal 11 include at least two contact elements 16. The contact elements 16 jointly form a conductor clamping slot 17. The contact elements 16 are thus designed and formed for clamp-contacting the electrical conductor 15. The contact elements 16 are each connected to soldering pins 32 for mounting on a circuit board, or alternatively are integral with the contact elements 16. Alternatively, the contact elements 16 are connected to additional connection assemblies.

The tool includes a housing element 18 that is designed to be placed onto the contact elements 16 of the insulation-displacement terminal 11. The housing element 18 comprises a first recess 19 which is formed and designed to receive a stamping element 21. The housing element 18 additionally includes a second recess 20. The stamping element 21 is mounted in the first recess 19, which is preferably formed as a through-recess, so as to be movable in a conductor insertion direction 22. The second recess 20 is designed to receive the electrical conductor 15 transversely to the conductor insertion direction 22, such that the conductor 15 inserted into the second recess 20 can be pushed into the conductor clamping slot 17 by means of the stamping element 21, in order to place the electrical conductor 15 onto the insulation-displacement terminal 11.

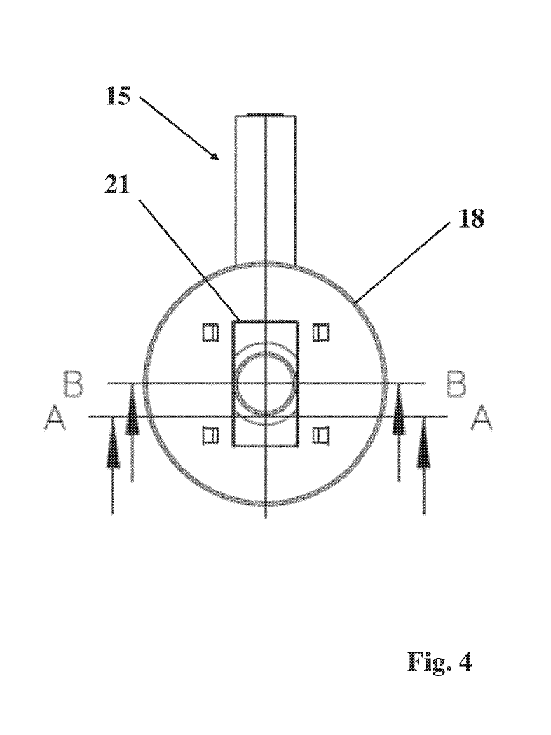

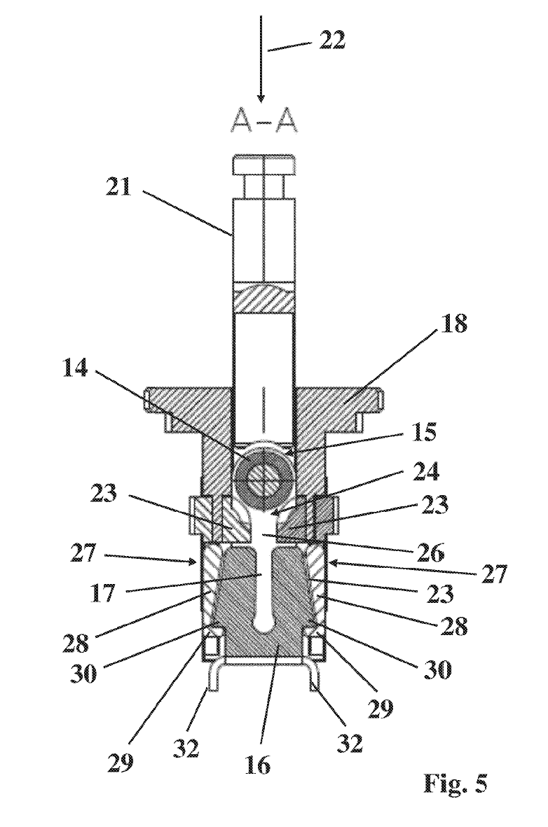

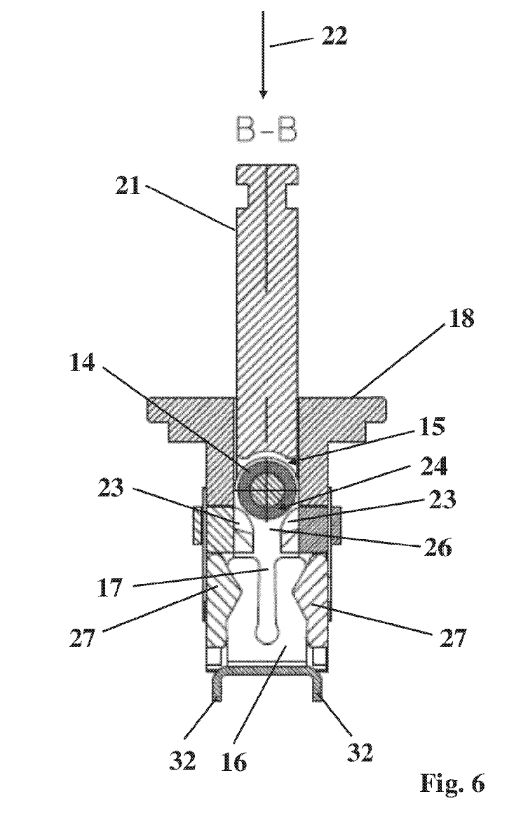

FIGS. 2 and 3 show the electrical conductor 15 in a placed position in which the electrical conductor 15 has already been inserted into the second recess 20 of the tool; however, the stamping element 21 remains in an upper position, i.e. it has not yet moved towards the insulation-displacement terminal 11 in the conductor insertion direction. The positions of the individual components of the tool according to the invention can also be seen further in the placed position in FIGS. 4 to 6, which each show views in the placed position. For instance, FIG. 4 is a plan view of the tool, FIG. 5 is a sectional view of the tool shown in FIG. 4 according to sectional line A-A and FIG. 6 is a sectional view according to sectional line B-B.

The housing element 18 additionally includes cutting means 23 which form a cutting region 24. For this purpose, the cutting means 23 are arranged in the housing element 18 in such a way that, when the stamping element 21 is moved from the placed position into a clamped position in order to insert the electrical conductor 15 into the conductor clamping slot 17, the insulation 14 initially comes into engagement with the cutting means 23 and is severed in the process, at least in part. In other words, the cutting means 23 are designed to precut the insulation 14 of the electric conductor 15, before said conductor is pushed into the conductor clamping slot 17 by means of the stamping element 21.

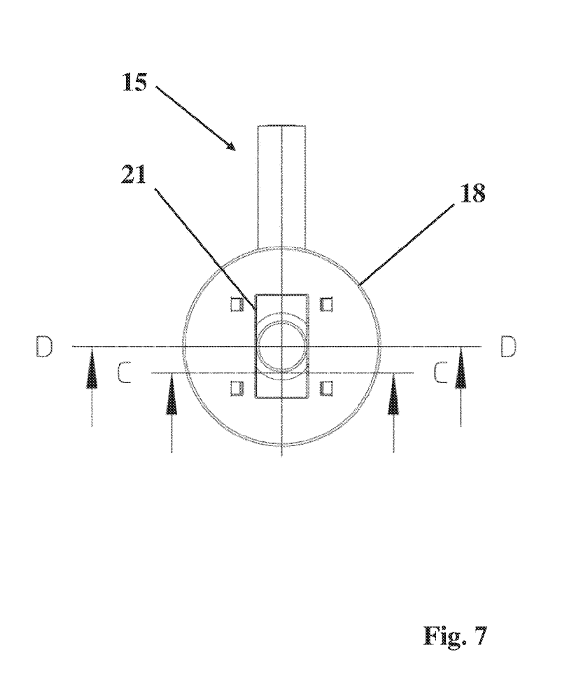

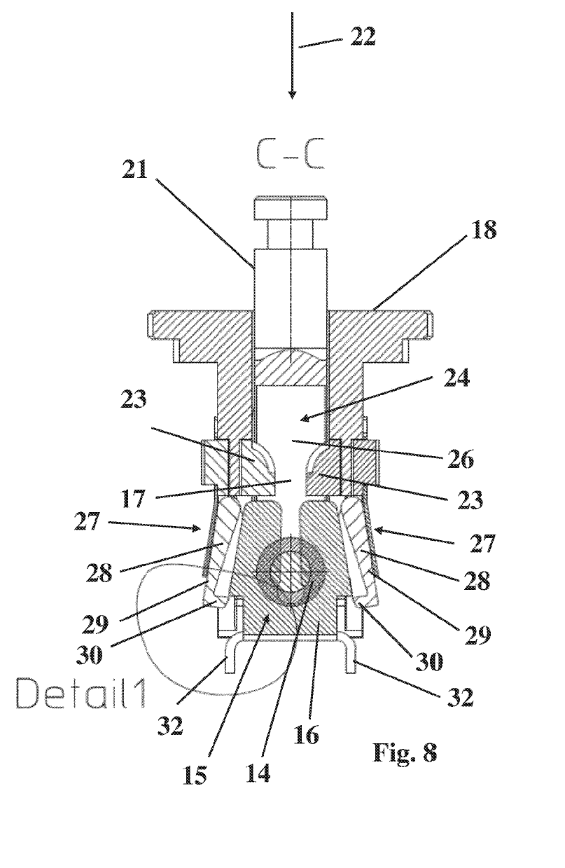

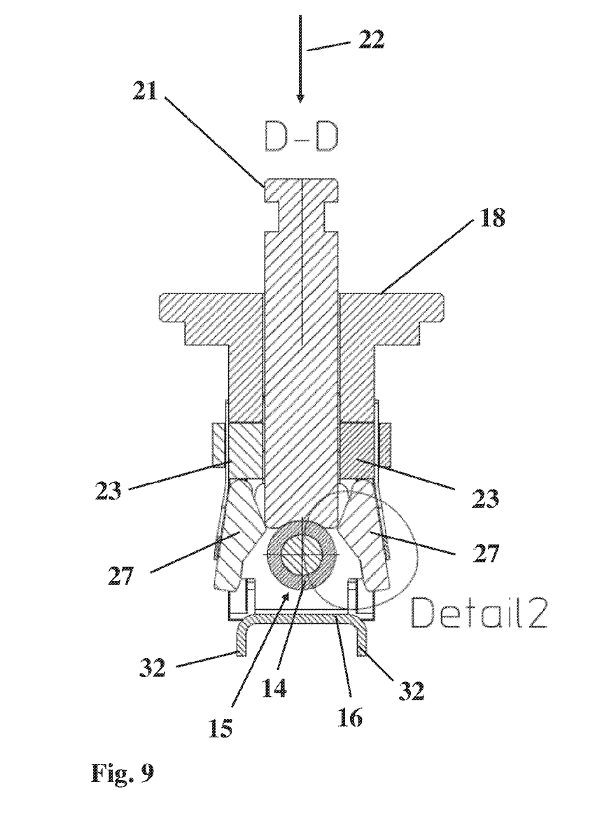

The tool according to the invention, together with the electrical conductor 15 inserted in the conductor clamping slot 17, is shown in the clamped position in FIGS. 7 to 9. FIG. 7 is a plan view of the tool in the clamped position, FIG. 8 is a sectional view of the tool shown in FIG. 7 according to sectional line C-C and FIG. 9 is a sectional view according to sectional line D-D.

The cutting means 23 preferably each include a double blade 25. The cutting means 23 together with the double blades 25 jointly form a tapered cutting gap 26. In this way, the insulation 14 is gradually cut into as the electrical conductor 15 is guided by means of the stamping element 21. This initial cut can be a partial cut, or alternatively can be a complete lateral severing of the insulation 14 in the portions of the insulation 14 that face the cutting means 23, such that, in any case, the electrical conductor 15 is freed from the insulation 14 in this partial region when said region penetrates the conductor clamping slot 17 in order to electrically contact the contact elements 16.

The cutting means 23 are preferably arranged in the housing element 18 such that one of the cutting means 23 is associated with each of the contact elements 16, the cutting gap 26 of the cutting means 23 transitioning into the relevant conductor clamping slot 17. In other words, the cutting means 23 are arranged in the housing element 18 so as to be upstream of the contact elements 16. The electrical conductor 15 together with the insulation 14 thereof thus initially passes through the cutting means 23 in order to precut the insulation 14 and, with the insulation 14 having been precut, is subsequently pushed into the conductor clamping slot 17 by the stamping element 21. The cutting means 23 are advantageously wedge-shaped, specifically so as to widen in the conductor insertion direction 22. The wedge-shaped embodiment of the cutting means 23 supports, on the one hand, the cutting action of the cutting means 23 when cutting into the insulation 14 and, on the other hand, results in the insulation 14 being forced out by the relevant incision. The cutting means 23 are preferably arranged in the housing element 18 by means of spring elements 31.

The housing element 18 particularly preferably includes holding means 27 that are formed and designed so as to come into holding engagement with the insulation-displacement terminal 11 in the placed position. The function of the holding means 27 can be seen in particular in FIG. 5. The holding means 27 are preferably formed so as to automatically lock such that, when the tool according to the invention is placed on the insulation-displacement terminal 11 in the placed position, the holding means 27 come into engagement with the insulation-displacement terminal 11. In this way, the tool according to the invention is mechanically connected to the insulation-displacement terminal 11 until the definitive insertion of the electric conductor 15 into the conductor clamping slot 17.

The holding means 27 are preferably arranged so as to be pivotable on the housing element 18 and are formed and designed such that at least one of the contact elements 16 is engaged therebehind in the placed position, at least in part. For this purpose, the holding elements 27 are preferably L-shaped, or are substantially L-shaped limb elements 28, as shown in the drawings.

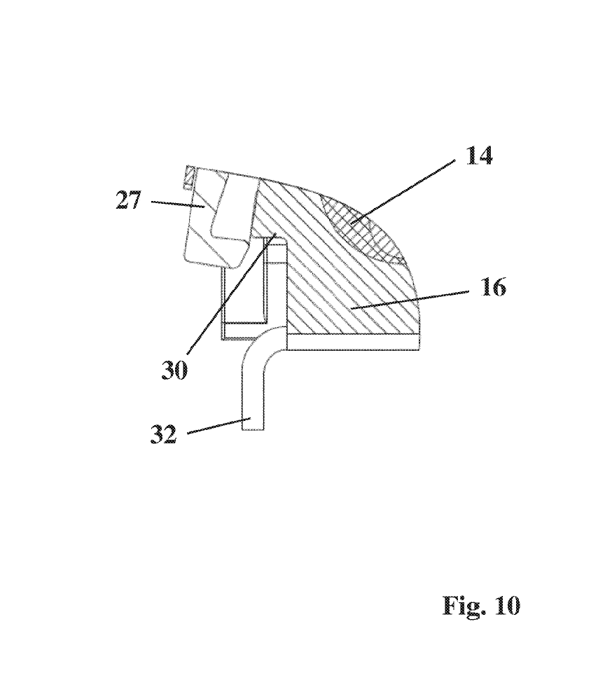

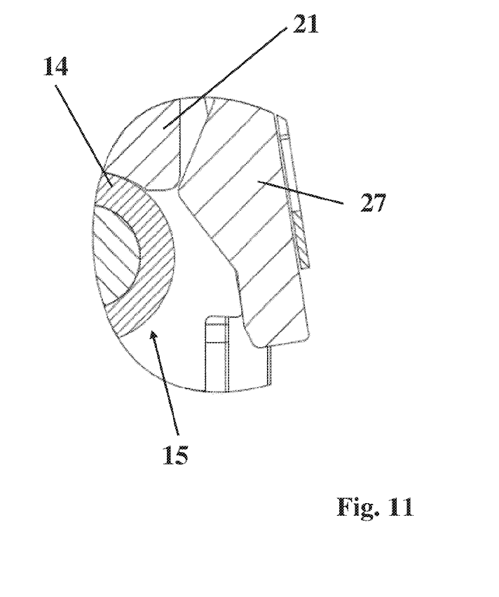

The holding means 27 are preferably arranged on or in the housing element 18 such that, in the clamped position, they are pivoted outwardly by means of the stamping element 21. This can be seen in particular in FIGS. 10 and 11, which reproduce a detailed view of detail 1 and detail 2 as shown in FIG. 8. On account of the stamping element 21 and the holding means 27 being designed to be pivoted outwardly in the clamped position, each free limb 29 comes free from the insulation-displacement terminal 11 or from the relevant contact element 17 thereof, such that the tool according to the invention can be detached from the insulation-displacement terminal 11.

According to the present invention, the insulation-displacement terminal 11 can be adapted and designed for clamp-contacting the insulation-coated 14 electrical conductor 15 by means of the previously described tool. For this purpose, the insulation-displacement terminal 11 includes, in addition to the contact elements 16 that form the conductor clamping slot 17 for the electrical conductor 15, in each case an undercut 30 that is designed and formed to come into holding engagement with the holding means 27 of the tool in the placed position. As shown in detail in FIG. 10, the free limb 29 is designed to engage around the undercut 30, such that the tool according to the invention is locked to the insulation-displacement terminal 11 until the electrical conductor 15 has reached the desired insertion depth in the conductor clamping slot 17 in the clamped position so as to form a clamping contact between the electrical conductor 15 and the contact elements 16.

The contact elements 16 having the undercut 30 are advantageously trapezoidal. In other words, the contact element 16 is formed so as to widen in the conductor insertion direction 22 as far as the undercut 30, such that, when the tool according to the invention is placed onto the insulation-displacement terminal 11, the holding means 27 are initially pushed outwards in order to then form a latched connection by interacting with the undercut 30. The latched connection is additionally designed to be detached by the stamping element 21 in the clamped position, by the holding means 27—as described previously—being pushed outwards.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

11 insulation-displacement terminal
12 conductor end
13 conductor longitudinal side
14 insulation
15 electrical conductor
16 contact elements
17 conductor clamping slot
18 housing element
19 first recess
20 second recess
21 stamping element
22 conductor insertion direction
23 cutting means
24 cutting region
25 double blade
26 cutting gap
27 holding means
28 L-shaped limb elements
29 free leg
30 undercut
31 spring elements
32 soldering pin

1. A tool for connecting an insulation-coated electrical conductor to an insulation-displacement terminal, the insulation-displacement terminal including at least two contact elements that jointly form a conductor clamping slot and are configured for clamp-contacting the electrical conductor, the tool comprising:
a housing element configured to be placed onto the contact elements, the housing element comprising a first recess configured to receive a stamping element that is mounted so as to be movable in a conductor insertion direction, and a second recess configured to receive the electrical conductor transversely to the conductor insertion direction,
wherein a cutter that forms a cutting region is arranged in the housing element in such a way that, when the stamping element is moved from a placed position into a clamped position in order to insert the electrical conductor into the conductor clamping slot, the insulation initially comes into engagement with the cutter and is severed in the process, at least in part.

2. The tool according to claim 1, wherein the cutter includes a double blade forming a tapered cutting gap.

3. The tool according to claim 2, wherein the cutter is arranged in the housing element, such that one of the cutters is associated with each of the contact elements, the cutting gap of the cutter transitioning into the relevant conductor clamping slot.

4. The tool according to claim 1, wherein the cutter is wedge-shaped so as to widen in the conductor insertion direction.

5. The tool according to claim 1, wherein the housing element includes a holder that is formed and designed so as to come into holding engagement with the insulation-displacement terminal in the placed position.

6. The tool according to claim 5, wherein the holder is arranged and configured so as to be pivotable on the housing element in order to engage at least in part behind at least one of the contact elements in the placed position.

7. The tool according to claim 5, wherein, in order to detach the tool from the insulation-displacement terminal in the clamped position, the holder is arranged so as to be outwardly pivotable by the stamping element.

8. An insulation-displacement terminal, adapted and configured for clamp-contacting an insulation-coated electrical conductor by applying the tool according to claim 1, the insulation-displacement terminal including contact elements that jointly form a conductor clamping slot, wherein the contact elements each comprise an undercut that is configured and formed so as to come into holding engagement with a holder of the tool in the placed position.

9. The insulation-displacement terminal according to claim 8, wherein the contact elements having the undercut are trapezoidal.
